(19) United States
(12) Patent Application Publication
(10) Pub. No.: US 2020/0158179 A1
(43) Pub. Date: May 21, 2020

(54) Labyrinth Sealing Device

(71) Applicant: Aktiebolaget SKF

(72) Inventor: Andrea Serafini, Pinerolo (IT)

(21) Appl. No.: 16/683,947

(22) Filed: Nov. 14, 2019

(30) Foreign Application Priority Data
Nov. 19, 2018 (IT) 102018000010424

(51) Int. Cl. F16C 33/80; F16C 19/18

(52) U.S. Cl. CPC F16C 33/805; F16C 33/7886; F16C 19/186

(57) ABSTRACT

A sealing device for a bearing unit having a rotatable portion, a stationary portion, at least one sealing lip mounted on the stationary portion for contacting the rotatable portion and having a predetermined thickness (S); and a screen which forms a labyrinth seal with the stationary portion and has an axial length (L1) with dimensions greater than the dimensions of the thickness (S) of the at least one lip and dimensions smaller than a non-integral multiple (M) of the thickness (S) of the at least one lip equal to 1.75.

### CROSS-REFERENCE TO RELATED APPLICATION

This application claims the benefit of priority to Italian Application No. 102018000010424 of the same title filed on Nov. 19, 2018, under 35 U.S.C. § 119, the entire contents of which are incorporated herein by reference.

### FIELD

The example embodiments disclosed herein relate to a cassette sealing device having innovative characteristic features and intended to be applied to bearing units.

### BACKGROUND

Generally, bearing units are exposed to contaminants of various types, for example suspended particulate matter and/or particles in a solution. Therefore, bearing units, including those forming part of wheel hub assemblies of motor vehicles, are provided with suitable sealing devices. An example of a sealing device is a cassette seal including two parts and comprising a rotatable portion mounted on a radially inner ring, and a stationary portion mounted on a radially outer ring. The stationary portion of the seal comprises a pair of lips which are made of elastomeric material and make contact with the rotatable portion and ensure inward sealing of the bearing unit. In some bearing units, the rotatable portion may be configured to form a labyrinth.

### BRIEF DESCRIPTION OF THE DRAWINGS

FIG. 1 is a partially cross-sectioned view of a wheel hub assembly provided with a sealing device according to an example embodiment of this disclosure;

FIG. 2 is a detail of a cassette sealing device according to a first example embodiment of the disclosure; and

FIG. 3 is a detail of a cassette sealing device according to a second example embodiment of the disclosure.

### DETAILED DESCRIPTION

The example embodiments in accordance with this disclosure are suitable for the wheel hub assemblies of motor vehicles, wherein the assemblies being provided with a bearing unit. These applications comprise both the case where the outer ring of the bearing is rotating, while the inner ring of the bearing is fixed, and the opposite case where the inner ring rotates and the outer ring is fixed. The example embodiments are also suitable, for example, to a bearing unit having a double row of balls.

Sealing devices having rotatable portions which do not include screens expose the edge of the outermost lip to water and contaminants which may penetrate inside the sealing device through the gap present between the rotatable portion and the stationary portion. A rotatable portion having a screen forms a labyrinth which protects the outer lip of the sealing device from the direct flow of water and contaminants, but may also prevent contaminants from flowing out and allow the accumulation of mud which the water, also present, is unable to remove. This drawback reduces the working life of the wheel hub assembly, resulting in faster wear of the lips and negative affecting operation of the entire bearing unit. Other drawbacks of labyrinth sealing devices are that they penalize the design of the lips and in particular limit their radial extension, since these labyrinth-type solutions require a significant amount of radial space. The cassette sealing device of example embodiments of the disclosure do not have the aforementioned drawbacks.

An example embodiment of the disclosure is to provide a cassette sealing device, for example for a bearing unit of a wheel hub assembly, wherein the device is provided both with a screening function in respect of external contaminants and with a geometrical form which favours the drainage of the albeit limited flow of contaminants which have penetrated inside the sealing device.

On the one hand, the novel solution may be provided with a screen having a labyrinth function for protecting the lip from the direct flow of water and contaminants, directing it towards the outside of the wheel hub assembly.

On the other hand, the labyrinth solution may be such that water and contaminants which have penetrated inside the sealing device are not prevented from flowing out, and, for this purpose, the size of the screen with a labyrinth function must be optimized so that the length of the labyrinth is sufficiently small. In this way the water may easily wash away any mud which could accumulate inside or at worst allow the accumulation of only a negligible amount of mud.

The example embodiments of the disclosure may also be applied to a sealing device provided with an encoder.

According to another aspect of the example embodiments of the disclosure, a wheel hub assembly having a bearing unit provided with the sealing device according to the example embodiments is also described.

Example embodiments will now be described with reference to a wheel hub assembly for motor vehicles, provided with a bearing unit having a sealing device according to example embodiments of the disclosure.

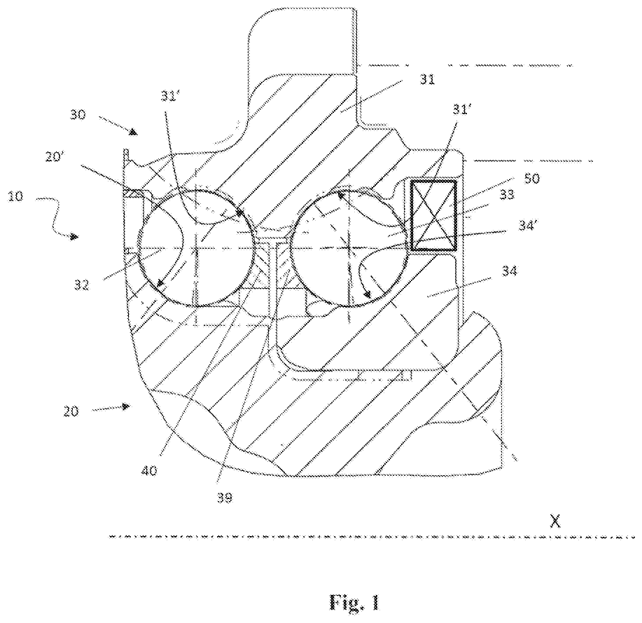

With reference to FIG. 1, a wheel hub assembly according to an example embodiment of the disclosure is denoted overall by 10. The figure shows a detail of the configuration illustrated by way of example.

The assembly 10 has a central rotation axis X and comprises a hub 20 which may be rotatable and a bearing unit 30 in turn comprising:
a radially outer ring 31 which may be stationary;
a radially inner ring 20 defined by the hub 20;
a further, rotatable, radially inner ring 34 mounted on and integral with the hub 20;
two rows of rolling bodies 32, 33, in this example balls, arranged between the radially outer ring 31 and the radially inner rings 20 and 34; and
two cages 39 and 40 for keeping in position the rolling bodies of the rows of rolling bodies 32, 33.

Alternatively, hub 20 and inner ring 34 may be stationary, and outer ring 31 may be rotatable.

In the whole of the present description and the claims, the terms and expressions indicating positions and orientations such as “radial” and “axial” are understood as being in relation to the central axis of rotation X of the bearing unit 30. Expressions such as “axially outer” and “axially inner” refer instead to the assembled condition of the wheel hub assembly and, in the specific case, preferably refer to a wheel side and to a side opposite to the wheel side, respectively.

The radially outer ring 31 is provided with two respective radially outer raceways 31′, while the radially inner rings 20, 34 are provided with respective radially inner raceways 20′, 34′ for allowing rolling of the row of axially outer rolling bodies 32 arranged between the radially outer ring 31 and the hub 20 and the row of axially inner rolling bodies 33 between the radially outer ring 31 and the radially inner ring 34. For the sake of simpler illustration the reference numbers 32, 33 will be used to indicate both the single balls and rows of balls. Again for the sake of simplicity, the term “ball” may be used by way of example in the present description and in the attached drawings instead of the more generic term “rolling body” (and likewise the same reference numbers will also be used). The wheel hub assembly 10 is provided with at least one cassette sealing device 50, for example, a device mounted on the axially outer side of the bearing unit.

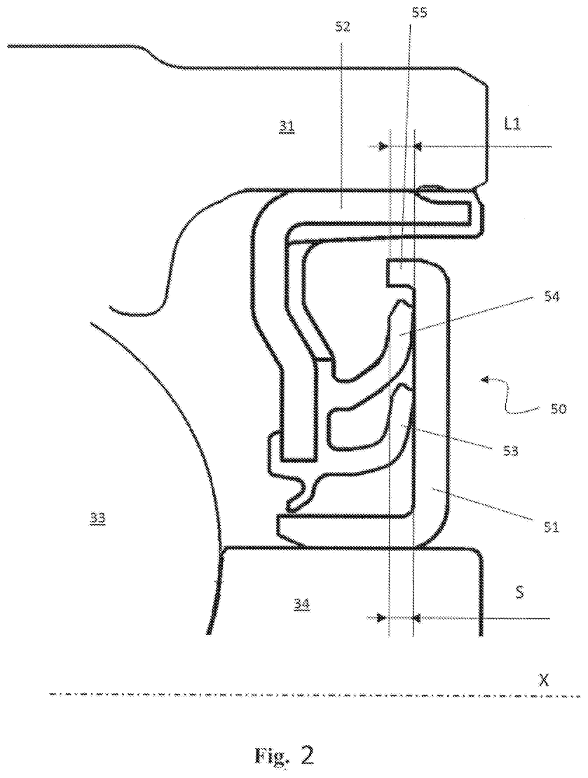

With reference to FIG. 2, the sealing device 50 may be a cassette seal i two parts and comprising a rotatable portion 51, mounted on the radially inner ring 34, and a stationary portion 52, mounted on the radially outer ring 31. The stationary portion 52 of the sealing device 50 comprises a pair of lips 53, 54 which are made of elastomeric material and make contact with the rotatable portion and ensure inward sealing of the bearing. The sealing device 50 could also comprise a radial sealing lip (not shown in the figure), in addition to or instead of the innermost axial lip. In any case it is to be understood that the design, the arrangement and the quantity of the sealing lips could change without thereby departing from the scope of the example embodiments.

The sealing device 50 and in particular its rotatable portion 51 is provided with a screen 55, in the radially outer portion with respect to the rotatable portion, which forms a labyrinth seal between the rotatable portion 51 and the stationary portion 52 of the sealing device 50. The axial dimension L1 of the screen 55 is however optimized so that the length of the labyrinth is sufficiently reduced. In this way the water may easily wash away any mud which could accumulate inside or at worst allow the accumulation of a negligible amount of mud. In particular the experiments carried out on this solution have shown that a good trade-off between the function of barrier against external contaminants and the function allowing drainage of contaminants which have accumulated inside the sealing device is obtained if the axial length L1 of the screen 55 has dimensions greater than the dimensions of the thickness S of the lip 53, 54 and dimensions smaller than a non-integral multiple M of the thickness S of the lip 53, 54 equal to 1.75.

In other words, the axial length L1 of the screen 55 must lie within a range which varies from the value of the thickness of the lip 53, 54 to the same value increased by 75%.

A better, and therefore preferable, trade-off is obtained if the axial length L1 has dimensions greater than the dimensions of the thickness S of the lip 53, 54 and dimensions smaller than the non-integral multiple M of the thickness of the lip 53, 54 equal to 1.50, namely if the axial length L1 of the screen 55 lies within a range which varies from the value of the thickness of the lip 53, 54 to the same value increased by 50%.

Even more preferably, the axial length L1 of the screen 55 could have dimensions greater than the dimensions of the thickness S of the lip 53, 54 and dimensions smaller than the non-integral multiple M of the thickness S of the lip 53, 54 equal in this case to 1.25. In other words, the axial length L1 of the screen 55 should lie within a range which varies from the value of the thickness of the lip 53, 54 to the same value increased by 25%.

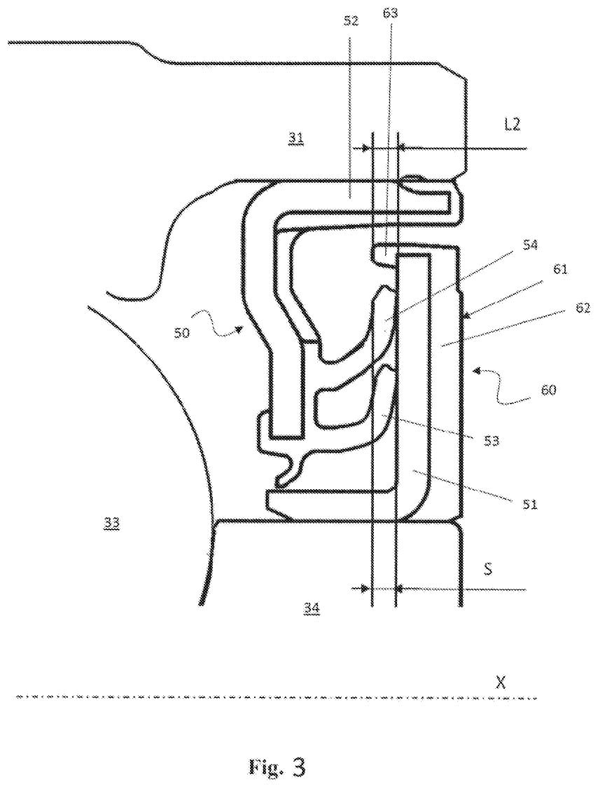

With reference to FIG. 3, a sealing device 50 provided with an encoder 60 is illustrated. The encoder is in the form of annular disc 61 made of plastic or magnetized rubber and comprises a metal insert 62 with a thickness of between 0.6 and 0.8 mm, having a structural function and being stably connected to the plastic or magnetized rubber portion, for example by means of gluing. The metal insert 62 is stably connected by means of force-fit to the radially inner ring 34 of the bearing unit.

According to an example embodiment, the metal insert of the encoder is provided with a screen 63, in the radially outer position with respect to the insert 62, which forms (in entirely the same way as in the preceding solution) a labyrinth seal with the stationary portion 51 of the sealing device 50. The axial dimension L2 of the screen 63 is optimized, also according to this example embodiment, so that the length of the labyrinth is sufficiently reduced.

The same experiments confirmed the same results obtained with the solution according to FIG. 2 (without encoder). To summarize, a good trade-off between the function of barrier against external contaminants and the function allowing drainage of contaminants which have accumulated inside the sealing device is obtained if the axial length L2 of the screen 63 has dimensions greater than the dimensions of the thickness S of the lip 53, 54 and dimensions smaller than a non-integral multiple M of the thickness S of the lip 53, 54 equal to 1.75.

A better, and therefore preferable, trade-off is obtained if the axial length L2 of the screen 63 has dimensions greater than the dimensions of the thickness S of the lip 53, 54 and dimensions smaller than the non-integral multiple M of the thickness S of the lip 53, 54 equal to 1.50.

Even more preferably, the axial length L2 of the screen 63 could have dimensions greater than the dimensions of the thickness S of the lip 53, 54 and dimensions smaller than the non-integral multiple of the thickness S of the lip 53, 54 equal in this case to 1.25.

In addition to the example embodiments of this disclosure, as described above, it is to be understood that numerous further variants are possible. It may also be understood that the embodiments are only examples and do not limit the subject of the inventive concepts, nor its applications, nor its possible configurations. On the contrary, although the description provided above enables the person skilled in the art to implement at least one of the example embodiments, it must be understood that numerous variations of the components described herein are feasible, without thereby departing from the scope of the example embodiments, as defined in the accompanying claims, interpreted literally and/or in accordance with their legal equivalents.

What is claimed is:

1. A sealing device for a bearing unit, the sealing device comprising:
a rotatable portion,
a stationary portion;
at least one sealing lip mounted on the stationary portion for contacting the rotatable portion and having a predetermined thickness (S); and
a screen which forms a labyrinth seal with the stationary portion;
wherein the sealing device has an axial length (L1, L2) with dimensions greater than the dimensions of the thickness (S) of the at least one sealing lip and dimensions smaller than a non-integral multiple (M) of the thickness (S) of the at least one sealing lip; said non-integral multiple (M) being equal to 1.75.

2. The sealing device of claim 1, wherein said non-integral multiple (M) is equal to 1.50.

3. The sealing device of claim 2, wherein said non-integral multiple (M) is equal to 1.25.

4. The sealing device of claim 1, wherein the rotatable portion of the sealing device is provided with the screen in a radially outer position.

5. The sealing device of claim 1, further comprising an encoder provided with a metal insert and the screen, wherein the screen is connected to the metal insert in a radially outer position.

6. A bearing unit comprising:
a radially outer ring having two raceway surfaces;
a first radially inner ring having a raceway surface and a second radially inner ring mounted on the first radially inner ring and having a raceway surface;
two rows of rolling bodies disposed between the raceway surfaces of the first and second radially inner rings and the outer ring;
at least one sealing device mounted between the second radially inner ring and the outer ring, wherein the sealing device comprises:
a rotatable portion,
a stationary portion;
at least one sealing lip mounted on the stationary portion for contacting the rotatable portion and having a predetermined thickness (S); and
a screen which forms a labyrinth seal with the stationary portion;
wherein the screen has an axial length (L1, L2) with dimensions greater than the dimensions of the thickness (S) of the at least one sealing lip and dimensions smaller than a non-integral multiple (M) of the thickness (S) of the at least one sealing lip; said non-integral multiple (M) being equal to 1.75.

7. The bearing unit of claim 6, wherein said non-integral multiple (M) is equal to 1.50.

8. The sealing device of claim 7, wherein said non-integral multiple (M) is equal to 1.25.

9. The bearing unit of claim 6, wherein the rotatable portion of the sealing device is provided with the screen in a radially outer position.

10. The bearing unit of claim 6, further comprising an encoder provided with a metal insert and the screen, wherein the screen is connected to the metal insert in a radially outer position.

11. A wheel hub assembly for motor vehicles, comprising:
a hub; and
a bearing unit comprising:
a radially outer ring having two raceway surfaces;
a raceway surface on the hub;
a radially inner ring mounted on the hub and having a raceway surface;
two rows of rolling bodies disposed between the raceway surfaces of the hub, the radially inner ring and the outer ring;
at least one sealing device mounted between the radially inner ring and the outer ring, wherein the sealing device comprises:
a rotatable portion,
a stationary portion;
at least one sealing lip mounted on the stationary portion for contacting the rotatable portion and having a predetermined thickness (S); and
a screen which forms a labyrinth seal with the stationary portion;
wherein the screen has an axial length (L1, L2) with dimensions greater than the dimensions of the thickness (S) of the at least one sealing lip and dimensions smaller than a non-integral multiple (M) of the thickness (S) of the at least one sealing lip; said non-integral multiple (M) being equal to 1.75.

12. The wheel hub assembly of claim 11, wherein said non-integral multiple (M) is equal to 1.50.

13. The wheel hub assembly of claim 12, wherein said non-integral multiple (M) is equal to 1.25.

14. The wheel hub assembly of claim 11, wherein the rotatable portion of the sealing device is provided with the screen in a radially outer position.

15. The wheel hub assembly of claim 11, further comprising an encoder provided with a metal insert and the screen, wherein the screen is connected to the metal insert in a radially outer position.
